(19) United States
(12) Patent Application Publication
(10) Pub. No.: US 2024/0111042 A1
(43) Pub. Date: Apr. 4, 2024

(54) DEVICE FOR MEASURING THE BODY HEIGHT OF A VEHICLE

(71) Applicant: ZF CV Systems Global GmbH, Bern (CH)

(72) Inventors: Konrad Feyerabend, Hannover (DE); Oliver Topic, Hannover (DE); Frank Van Son, Tilburg (NL); Julian Weitkamp, Kirchlengern (DE)

(21) Appl. No.: 18/475,004

(22) Filed: Sep. 26, 2023

(30) Foreign Application Priority Data
Sep. 26, 2022 (DE) 10 2022 124 631.0

(51) Int. Cl. G01S 13/08

(52) U.S. Cl. CPC G01S 13/08

(57) ABSTRACT

A device is for determining the body height of a vehicle by contactless measurement of the distance between body or frame of the vehicle and a vehicle part connected to the chassis. The device includes a transmitter and a receiver, which emit a high-frequency signal directed toward the vehicle part and receive and process the reflected signal. The reflected signal is evaluated via an algorithm stored in a control unit assigned to the device and the distance, which can be calculated from the signal, of the vehicle part to the transmitter and receiver is determined. The transmitter is assigned to a damper or stop buffer arranged on the body or frame and emits a high-frequency signal onto a stop surface, which is provided for the damper or stop buffer and is arranged on the chassis, and the receiver receives the signal reflected from the stop surface.

### CROSS-REFERENCE TO RELATED APPLICATIONS

This application claims priority of German patent application no. 10 2022 124 631.0, filed Sep. 26, 2022, the entire content of which is incorporated herein by reference.

### TECHNICAL FIELD

The disclosure relates to a device for determining the body height of a motor vehicle by contactless measurement of the distance between body or frame of the motor vehicle and a vehicle part connected to the chassis of the motor vehicle, wherein the device includes a transmitting unit and a receiving unit, which emits a high-frequency signal directed onto the vehicle part and receives and processes the reflected signal, wherein the reflected signals are evaluated with the aid of an algorithm stored in a control unit assigned to the device and the distance, which can be calculated therefrom, of the vehicle part from the emitting and receiving unit is determined. The disclosure also relates to a damper or stop buffer in the chassis region of a vehicle and a motor vehicle having a device according to the disclosure and a method for operating the device according to the disclosure.

### BACKGROUND

The current electronic chassis controllers and motor vehicles and in particular in trucks, buses, or trailers are dependent on signals of sensors, with the aid of which the height of the structure or the body above the axle can be measured. These measured values represent current loading and driving states and thus represent the input signals which a level regulation system requires so that the regulating algorithm stored therein is capable of working at all.

Mechanical height sensors are known here as relatively simple sensors, for example, the frequently used rotational angle sensors, with the aid of which a spring travel is converted via a lever mechanism into a rotational movement, by which a height change, for example, of a vehicle axle or a chassis element may be determined. The lever mechanism of such rotational angle sensors is of course relatively susceptible to damage or soiling. In particular icing can represent an influence of such a system. Moreover, corresponding installation spaces are required in the chassis region and noticeable tolerance chains are to be taken into consideration.

DE 102 55 438 A1 discloses a device for determining the vehicle height above the roadway in the region of a wheel of a vehicle, in which a distance sensor is arranged for the contactless measurement of a chassis part, of the wheel or the axle of the vehicle here. An embodiment disclosed therein includes a radar sensor as a distance sensor. Soiling or icing in the chassis region can sometimes also strongly change the measurement result here, however.

WO 2007/137647 discloses a radar transmitting unit and a radar receiving unit at the end elements of an air spring, which are arranged inside the air spring bellows and using which the spring height of the air spring is measured. Environmental influences are less relevant in such a system, however, the sensors provided therein can only be integrated with a relatively high expenditure into the suspension components.

### SUMMARY

It is an object of the present disclosure to provide a device for measuring the body height of a motor vehicle via radar measurement using a simply constructed sensor unit that can be installed easily in or on the vehicle, with the aid of which a measurement of the body height or the distance of a chassis part from the body, which is uninfluenced as much as possible by environmental influences, can be carried out.

This object is, for example, achieved via a device for determining a body height of a motor vehicle by contactless measurement of a distance between a body or a frame of the motor vehicle and a vehicle part connected to a chassis of the motor vehicle. The device includes: a transmitter and a receiver, which are configured to emit a high-frequency signal directed toward the vehicle part and receive and process the signal as a reflected signal; wherein the reflected signal is evaluated via an algorithm stored in an electronic circuit assigned to the device and a distance of the vehicle part to the transmitter and the receiver is determined which can be calculated from the reflected signal; the transmitter being assigned to an elastomeric damper or stop buffer arranged on the body or the frame of the motor vehicle and configured to emit a high-frequency signal onto a stop surface, which is provided for the damper or stop buffer and is arranged on the chassis of the motor vehicle; and, the receiver being configured to receive the signal reflected from the stop surface as the reflected signal.

A damper or stop buffer in the chassis region of a vehicle and a motor vehicle having a device according to the disclosure and a method for operating the device according to the disclosure are also disclosed.

The transmitter/transmitting unit is assigned here to an elastomer damper or stop buffer arranged on the body or frame of the motor vehicle and emits a high-frequency signal onto a stop surface, which is provided for the damper or stop buffer and is arranged on the chassis of the motor vehicle, wherein the receiver/receiving unit receives the signal reflected from the stop surface. The stop surface of the damper is used at the same time here as a reflection surface for the measuring device. In addition to the therefore simple integration of the measuring device within the other body or chassis parts, the advantage results here that the stop surface is to be kept free of soiling very easily in that, as is provided, for example, in the method according to the disclosure for operating the device, soiling or icing can crack off easily due to lowering and striking the damper on its stop surface and can thus be removed. The emitted signal is therefore always incident on a reflection surface of the chassis kept free of deposits or soiling.

In an embodiment of the disclosure, the transmitting unit and the receiving unit are formed adjacent to the damper or stop buffer and are provided for emitting and receiving ultrasonic waves or electromagnetic radiation, in particular radar radiation. An arrangement in which the transmitting unit and the receiving unit are formed directly adjacent to the damper or stop buffer represents a solution here which is particularly simple to implement and is easy to handle with regard to recalibration.

In a further embodiment of the disclosure, the transmitting unit and the receiving unit are provided inside the damper or stop buffer and are configured for emitting and receiving electromagnetic radiation, in particular radar radiation. Transmitting unit and receiving unit are accommodated particularly well protected in the chassis region by such an arrangement. This is true in particular if the transmitting unit and the receiving unit are provided in the form of a sensor configured as a transceiver and therefore only have a small structural size.

In an embodiment of the disclosure, the damper or stop buffer is made of a material which is transmissive for radar radiation or has a low absorption rate for radar radiation, wherein a radar sensor configured as a transceiver is provided in a cavity of the damper or stop buffer closed toward the stop plate. The damper or stop buffer thus forms a type of closed housing for the transceiver and therefore has good mechanical protection. Depending on the intended use, similarly good protection is achieved in a further embodiment of the disclosure in which a radar sensor configured as a transceiver is provided in a cavity of the damper or stop buffer open toward the stop surface. In both cases, the cavity can be matched to the size and shape of the sensor.

A further configuration is that the radar sensor is fastened on a base plate of the damper or stop buffer and the damper or stop buffer can be materially bonded to the base plate, preferably by vulcanization or adhesive bonding. Such a configuration is advantageous if the production of the individual parts as individual assemblies or supplier parts possibly originating from different producers is provided. In this meaning as well, a configuration of the disclosure can thus be provided such that a radar sensor configured as a transceiver is integrated in the damper or stop buffer, preferably vulcanized in. Radar sensor and damper or stop buffer, as well as associated parts, such as a base plate for fastening on body, frame, or chassis, can thus be configured as individual parts or already provided as an assembly.

Good measurement results and sufficient accuracy are achieved in one configuration of the disclosure in which the emitting and receiving unit is operated using high-frequency radar radiation in the millimeter wave range.

In the meaning of the above-mentioned assemblies, a further aspect of the disclosure is that a damper or stop buffer is designed together with at least the base plate and the emitting and receiving unit for radar radiation as a prefinished unit fastenable on the vehicle, which is prefinished, for example, as a supplier part and can be directly installed by a vehicle body producer without further complex assembly of individual parts being required.

A further aspect of the disclosure relates to a motor vehicle, preferably a truck, having a device according to the disclosure for determining the vehicle body height. In such a vehicle, for example, in a vehicle having a level regulation system, the most accurate possible height measurements are important, which are to be implemented well by the device according to the disclosure.

A further aspect of the disclosure relates to the above-mentioned method for operating a device for determining the vehicle body height, wherein in case of soiling or icing of the stop surface provided for the damper or stop buffer on the chassis of the motor vehicle, lowering of the body or the frame up to contact of the damper or stop buffer on the stop surface is initiated. When the damper or stop buffer is set down, any soiling located on the stop surface is then pressed away or dislodged. It may be identified, for example, by the reflection behavior of the high-frequency signal or the radar beam whether soiling or icing is present.

The disclosure is to be explained in more detail on the basis of an embodiment having a sensor configured as a radar transceiver.

### BRIEF DESCRIPTION OF DRAWINGS

The invention will now be described with reference to the drawings wherein:

FIG. 1 shows, in the form of a schematic illustration, a detail of an attachment of an axle structure;

FIG. 2 and FIG. 3 show in detail, but also schematically, the assignment of a sensor configured as a transceiver to the elastomeric damper or stop buffer;

FIG. 4 shows an embodiment of the device according to the disclosure;

FIG. 5 shows another embodiment of the device according to the disclosure; and,

FIG. 6 shows a further embodiment of the device according to the disclosure.

### DETAILED DESCRIPTION

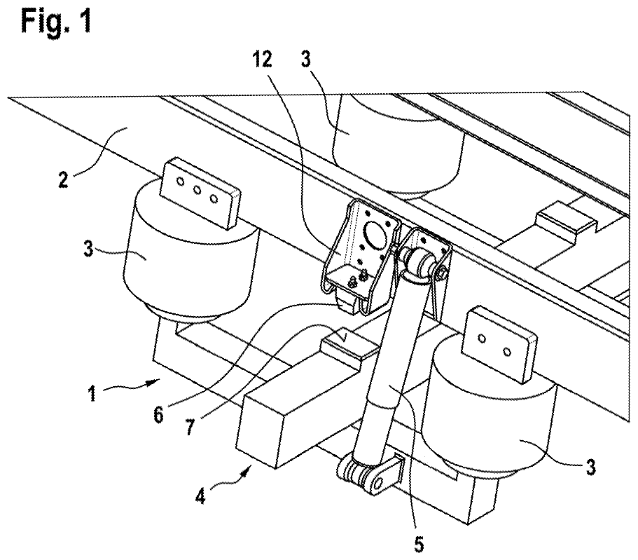

FIG. 1 shows, in the form of a schematic illustration, a detail of an attachment of an axle structure 4, which is connected to a chassis 1 of a motor vehicle, of a utility vehicle (not shown in greater detail here) to a ladder-type frame 2, which is outlined in some details here, and which supports its body or its cargo space or cargo surface in a known manner. Cargo space and cargo surface are also not shown in greater detail here, since they are not essential to the disclosure.

The attachment shown here between chassis and ladder-type frame includes air springs 3, using which the axle structure 4 is suspended and cushioned on the ladder-type frame 2.

Furthermore, a hydraulic shock absorber 5 is recognizable, which dynamically damps the axle structure 4 in relation to the ladder-type frame 2.

Furthermore, a damper or stop buffer 6 formed from elastomeric material can be seen, which limits the retraction of the chassis or the frame and can be used as an emergency spring when it rests on its stop surface 7. When the damper or stop buffer 6 is located on its stop surface 7, air springs 3 and hydraulic shock absorber 5 are thus located in their lowest position. In normal operation of the utility vehicle, the damper or stop buffer 6 is spaced apart from its stop surface 7.

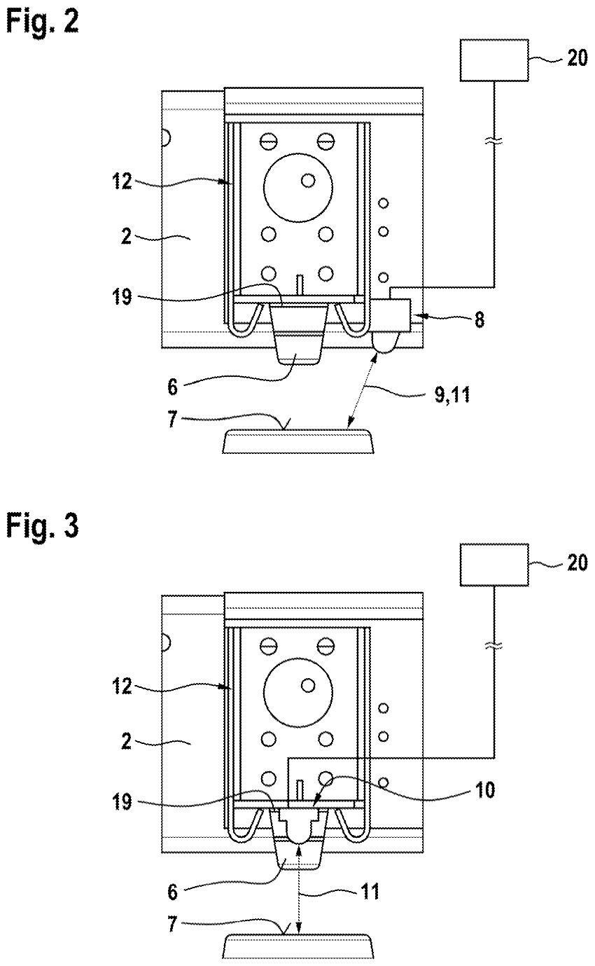

FIG. 2 and FIG. 3 now show in detail, but also schematically, the assignment of a sensor 8, 10 configured as a transceiver to the elastomeric damper or stop buffer 6, wherein the latter is fastened via its associated base plate 19 on a mount 12 flanged onto the truck ladder-type frame 2.

The sensor 8, 10 configured as a transceiver emits a high-frequency signal 9, 11 onto the stop surface 7, which is provided for the damper or stop buffer 6 and is arranged on the chassis of the motor vehicle, and receives the signal reflected from the stop surface. Both sensors 8 and 10 are configured here as radar sensors. The sensor 8 is formed adjacent to the damper or stop buffer 6 here, while the sensor 10 is provided inside the damper or stop buffer 6. It would thus also be possible, for example, to configure the sensor 8 as an ultrasonic sensor, since no elastomeric damper material has to be radiated through here. The use of an ultrasonic sensor would moreover also be possible in the application shown in FIG. 5.

The respective emitted high-frequency signals, radar beams here, are each shown by arrows or double arrows 9, 11.

An algorithm is stored in an electronic circuit assigned to the device, which processes the signal emitted by the transceiver and the reflected signal, evaluates the signals and determines the distance of the stop surface 7 from the sensor 8, 10 therefrom. With corresponding configuration of the associated software, icing or soiling on the stop surface is also thus detectable.

A vehicle control unit 20, only schematically indicated in FIGS. 2 to 6, can then process this evaluation as an input variable in order to raise or lower the vehicle, for example, via or within an electronically controlled air suspension, such as an ECAS (Electronically Controlled Air Suspension).

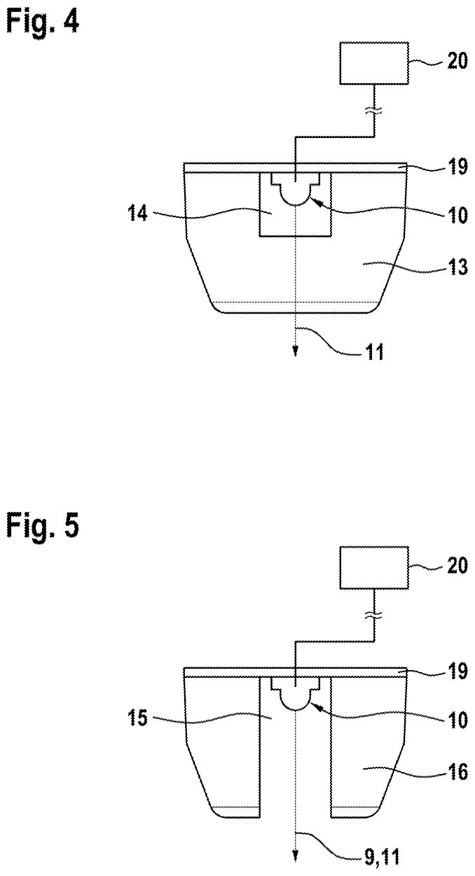

FIG. 4 shows an embodiment of the device according to the disclosure in which a radar sensor 10 configured as a transceiver is provided in a cavity 14, which is closed toward the stop plate, of a damper or stop buffer 13. The damper or stop buffer 13 includes a material which has a low absorption rate for radar radiation and can thus be penetrated by the radiation emitted by the radar sensor.

FIG. 5 shows another embodiment of the device according to the disclosure, in which a radar sensor 10 configured as a transceiver is provided in a cavity 15, which is open toward the stop surface, of a damper or stop buffer 16. As already mentioned, in this embodiment the use of an ultrasonic sensor would also be possible.

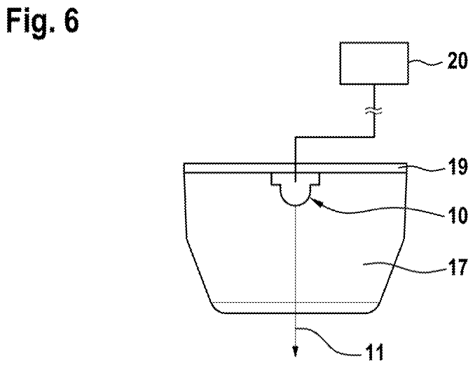

FIG. 6 shows a further embodiment of the device according to the disclosure in which a radar sensor 10 configured as a transceiver is vulcanized into the damper or stop buffer 17. The damper or stop buffer 17 also is made of a material which only has a low absorption rate for radar radiation.

FIGS. 2 to 6 each also show a base plate 19 associated with the device according to the disclosure, which is fastened on the mount 12 and is connected in each case to sensor 8, 10 and/or damper or stop buffer 6, 13, 16, 17. It is possible here that, for example, the radar sensor 8, 10 forms a prefinished assembly with the base plate 19 and can be materially bonded during the assembly to the damper or stop buffer 6, 13, 16, 17, preferably by vulcanization or adhesive bonding. Alternatively, sensor 8, 10, base plate 19, and damper or stop buffer 6, 13, 16, 17 can be provided as individual parts to be installed. Sensor 8, 10 and damper or stop buffer 6, 13, 16, 17 can also form a prefinished assembly.

It is understood that the foregoing description is that of the preferred embodiments of the invention and that various changes and modifications may be made thereto without departing from the spirit and scope of the invention as defined in the appended claims.

### LIST OF REFERENCE NUMERALS (PART OF THE DESCRIPTION)

1 truck chassis
2 ladder-type frame, truck ladder-type frame
3 air spring
4 axle structure
5 hydraulic shock absorber
6 damper or stop buffer
7 stop surface
8 radar sensor
9 high-frequency signal/radar or ultrasonic beam
10 radar sensor
11 high-frequency signal/radar beam
12 mount for damper or stop buffer
13 damper or stop buffer
14 cavity, closed toward the stop plate
15 cavity, open toward the stop plate
16 damper or stop buffer
17 damper or stop buffer
19 base plate
20 vehicle control unit

1. A device for determining a body height of a motor vehicle by contactless measurement of a distance between a body or a frame of the motor vehicle and a vehicle part connected to a chassis of the motor vehicle, the device comprising:
a transmitter and a receiver, which are configured to emit a high-frequency signal directed toward the vehicle part and receive and process the signal as a reflected signal;
wherein said reflected signal is evaluated via an algorithm stored in an electronic circuit assigned to the device and a distance of the vehicle part to said transmitter and said receiver is determined which can be calculated from said reflected signal;
said transmitter being assigned to an elastomeric damper or stop buffer arranged on the body or the frame of the motor vehicle and configured to emit a high-frequency signal onto a stop surface, which is provided for the damper or stop buffer and is arranged on the chassis of the motor vehicle; and,
said receiver being configured to receive said signal reflected from the stop surface as said reflected signal.

2. The device of claim 1, wherein said transmitter and said receiver are formed adjacent to the damper or stop buffer and are provided for emitting and receiving ultrasonic waves or electromagnetic radiation.

3. The device of claim 1, wherein said transmitter and said receiver are formed adjacent to the damper or stop buffer and are provided for emitting and receiving radar radiation.

4. The device of claim 1, wherein said transmitter and said receiver are provided inside the damper or stop buffer and are configured for emitting and receiving electromagnetic radiation.

5. The device of claim 1, wherein said transmitter and said receiver are provided inside the damper or stop buffer and are configured for emitting and receiving radar radiation.

6. The device of claim 1, wherein said transmitter and said receiver are provided in the form of a sensor configured as a transceiver.

7. The device of claim 4 further comprising:
a radar sensor configured as said transmitter and said receiver;
wherein said damper or stop buffer includes a material which has a low absorption rate for radar radiation; and,
said radar sensor being configured as a transceiver provided in a cavity of the damper or stop buffer closed toward said stop surface.

8. The device of claim 3, wherein said transmitter and said receiver are a sensor configured as a transceiver provided in a cavity of the damper or stop buffer open toward the stop surface.

9. The device of claim 7, wherein said radar sensor is fastened on a base plate of the damper or stop buffer and the damper or stop buffer is materially bondable to the base plate.

10. The device of claim 7, wherein said radar sensor is fastened on a base plate of the damper or stop buffer and the damper or stop buffer is materially bondable to the base plate by vulcanization or adhesive bonding.

11. The device of claim 6, wherein said sensor is a radar sensor and is integrated in the damper or stop buffer.

12. The device of claim 6, wherein said sensor is a radar sensor and is vulcanized in the damper or stop buffer.

13. The device of claim 3, wherein said transmitter and said receiver are operated using high-frequency radar radiation in the millimeter wave range.

14. A damper or stop buffer in a chassis region of a vehicle comprising:
a device for determining a body height of a motor vehicle by contactless measurement of the distance between a body or a frame of the motor vehicle and a vehicle part connected to a chassis of the motor vehicle;
said device including a transmitter and a receiver, which emit a high-frequency signal directed toward the vehicle part and receive and process the signal as a reflected signal;
wherein said reflected signal is evaluated via an algorithm stored in an electronic circuit assigned to the device and a distance of the vehicle part to said transmitter and said receiver is determined which can be calculated from said reflected signal;
said transmitter being assigned to the damper or stop buffer arranged on the body or the frame of the motor vehicle and configured to emit a high-frequency signal onto a stop surface, which is provided for the damper or stop buffer and is arranged on the chassis of the motor vehicle; and,
said receiver being configured to receive said signal reflected from the stop surface as said reflected signal;
a base plate;
wherein the damper or stop buffer is formed together with at least said base plate and said transmitter and said receiver as a prefinished unit configured to be fastened on the vehicle.

15. A motor vehicle comprising the device of claim 1.

16. The motor vehicle of claim 15 wherein the motor vehicle is a truck.

17. A method for operating the device for determining the body height of a motor vehicle by contactless measurement of the distance between a body or a frame of the motor vehicle and a vehicle part connected to a chassis of the motor vehicle, the device including a transmitter and a receiver, which are configured to emit a high-frequency signal directed toward the vehicle part and receive and process the signal as a reflected signal; wherein the reflected signal is evaluated via an algorithm stored in an electronic circuit assigned to the device and a distance of the vehicle part to the transmitter and the receiver is determined which can be calculated from the reflected signal; the transmitter being assigned to the damper or stop buffer arranged on the body or the frame of the motor vehicle and configured to emit a high-frequency signal onto a stop surface, which is provided for the damper or stop buffer and is arranged on the chassis of the motor vehicle; and, the receiver being configured to receive the signal reflected from the stop surface as the reflected signal; the method comprising:
lowering of the body or the frame until contact of the damper or stop buffer on the stop surface being initiated by a vehicle control unit in a case of soiling or icing of the stop surface provided for the damper or stop buffer on the chassis of the motor vehicle.
